(19) United States
(12) Patent Application Publication
(10) Pub. No.: US 2005/0121996 A1
(43) Pub. Date: Jun. 9, 2005

(54) Electric drive for a radial impeller

(75) Inventors: Edward Lopatinsky, San Diego, CA (US); Daniel Schaefer, Palm Desert, CA (US)

Correspondence Address: ROTYS Inc., 5450 Complex St. # 307, San Diego, CA, 92123, US

(73) Assignee: ROTYS Inc.

(21) Appl. No.: 10/987,541

(22) Filed: Nov. 12, 2004

Related U.S. Application Data
(60) Provisional application No. 60/520,069, filed on Nov. 14, 2003.

(51) Int. Cl. H02K 21/12; H02K 1/22; H02K 9/06; F04B 17/00

(52) U.S. Cl. 310/268; 310/166; 310/156.32; 417/423.7; 417/423.1; 310/62

(57) ABSTRACT

An electric drive for a radial impeller comprises a magnetized rotor and at least one flat stator. The magnetized rotor comprises magnetic means rigidly fixed with the radial impeller. The flat stator comprises circumferential arrayed coils and at least one ferromagnetic plate placed at an outer side of the flat stator opposite to the magnetized rotor, thus shortening magnetic fluxes generated by an interaction of electromagnetic fields of the magnetized rotor and the flat stator. The ferromagnetic plate is made from silicon steel comprising of at least 3% of silicium. The ferromagnetic plate at least partially covered the coils in direction perpendicular to the ferromagnetic plate.

### CROSS REFERENCE TO RELATED APPLICATIONS

The present application claims the benefit of priority of U.S. Provisional Patent Application Ser. No. 60/520,069, filed Nov. 14, 2003 for Edward Lopatinsky at al. the entire content of which is incorporated herein by reference.

### BACKGROUND OF THE INVENTION

The present invention relates generally to electric drives and is useful in direct current brushless motors, preferable in DC brushless motors for cooling systems with radial type blower and heatsink for regulating the temperature of electronic devices.

It is desirable to have small overall dimensions and high efficiency in electric drives. The trend toward smaller and thinner electronic devices having faster processors renders the traditional heat removal cooling systems inadequate. The electric drives of these systems should be small too. It is possible only if they have high efficiency. Higher efficiency also gives the higher number of revolutions taking the same amount of energy or takes the lower amount of energy having the same number of revolutions, —all this without increasing the volume.

There are known many types of electric drives with coils wrapped about a core, for example, like electric drive described in U.S. Pat. No. 5,440,185 “Composite magnet brushless DC motor”, comprising magnetic rotor and a stator with coils wrapped about ring-shape disk. These electric drives are not compact enough.

There are known electric drives with screens shielding some elements like sensor, Hall elements, etc, from magnetic fluxes generated by the rotor and/or the stator and made from the ferromagnetic material like iron (U.S. patent application No. 2001/0013731 “Motor” or DE patent application No. 4331862). These screens do not increase the efficiency of the electric drive.

There is known electric drive by U.S. Pat. No. 4,645,961 “Dynamoelectric machine” comprising a magnetic rotor and a ring-shaped cylinder stator, wherein said stator comprises plurality of circumferentially placed printed circuit coils that form two coil layers made as parts of a common multilayer printed circuit board, said coils of different layers are electrically connected and form together ring-shaped winding, two said coil layers of which are separated by a layer of an electro-insulating material.

There is known electric drive by WO patent application No. 03/003547 (PCT/US 02/20224) “Brushless DC Electric Motor” comprising a magnetic rotor and two ring-shaped disk stators, located on common axis on different sides from the rotor, wherein each of said stators comprises plurality of circumferentially placed printed circuit coils that form two coil layers made as parts of a common multilayer printed circuit board and located on different sides of electro-insulating layer, said coils of different layers are electrically connected forming together a ring-shaped disk winding.

Said electric drives with printed circuit boards are the most compact from all known. But the increase in efficiency could additionally decrease the amount of energy used or increase the number of revolutions, and also decrease their sizes.

It would be generally desirable to provide an electric drive for radial blower that has higher efficiency and, as a result, can give the higher number of revolutions and the possibility to decrease its overall sizes.

### SUMMARY OF THE INVENTION

According to the present invention an electric drive for a radial impeller comprises a magnetized rotor and at least one flat stator. The magnetized rotor comprises magnetic means rigidly fixed with the radial impeller. The magnetic means could be made like blades of the radial impeller. The flat stator comprises circumferential arrayed coils.

The general idea of the claimed invention is that the flat stator of the electric drive further comprises at least one ferromagnetic plate placed at an outer side of the flat stator opposite to the magnetized rotor, thus shortening magnetic fluxes generated by an interaction of electro-magnetic fields of the magnetized rotor and the flat stator. As a result the magnetic field in the area of interaction between the flat stator and the magnetized rotor is more intensive.

Conducted tests show, that in this case there is the following effect: the efficiency of the electric drive with ferromagnetic plate shortening the magnetic fluxes generated by the flat stator and the magnetized rotor is higher than in known electric drives. It gives the higher number of revolutions taking the same amount of energy or takes the lower amount of energy having the same number of revolutions, —without increasing of the total volume of the electric drive.

Above mentioned effect can be achieved if the ferromagnetic plate is made of the material with high eddy current resistance. In contrary, using of the ferromagnetic plate with low eddy current resistance not only does not give the effect but even lowers the efficiency of the electric drive because of currents induced in the ferromagnetic plate by rotating of the magnetized rotor. These currents lower the electromagnetic fields generated by the flat stator and the magnetized rotor.

According to the present invention the ferromagnetic plate is made from silicon steel. The best variant is when it is made from silicon steel comprising of at least 3% of silicium. It has the higher electrical resistance. In this case the electric drive has the higher efficiency. Tests show, that the minimum relative thickness of the ferromagnetic plate in respect to the outer diameter of the radial impeller is 0.001, and the best effect is when its relative thickness is 0.004-0.013, —the further increasing of the relative thickness practically does not give an additional effect.

The above mentioned effect of the increasing of efficiency of the electric drive becomes noticeable when the ferromagnetic plate at least partially covered the coils in direction perpendicular to the ferromagnetic plate and maximum of effect is observed when the ferromagnetic plate covered the coils in the same direction in full.

There is another design option of the present invention when the flat stator comprising at least two ferromagnetic plates separated from each other by a layer made of electric insulating material. As the tests show, such design additionally increases efficiency of the electric drive due to decreases currents inducing in the ferromagnetic plates comparing with one ferromagnetic plate.

According to the second embodiment the electric drive comprises two flat stators placed from both sides of the radial impeller thus increase the useful power of the electric drive when it's required.

### BRIEF DESCRIPTION OF THE SEVERAL VIEWS OF THE DRAWINGS

FIG. 1 is an exploded view showing the first embodiment of the electric drive according to the present invention.

FIG. 2 is an exploded view showing the second embodiment of the electric drive according to the present invention.

FIG. 3 is a perspective view showing an application of the electric drive according to the present invention when assembled in a radial blower.

### DETAILED DESCRIPTION OF THE INVENTION

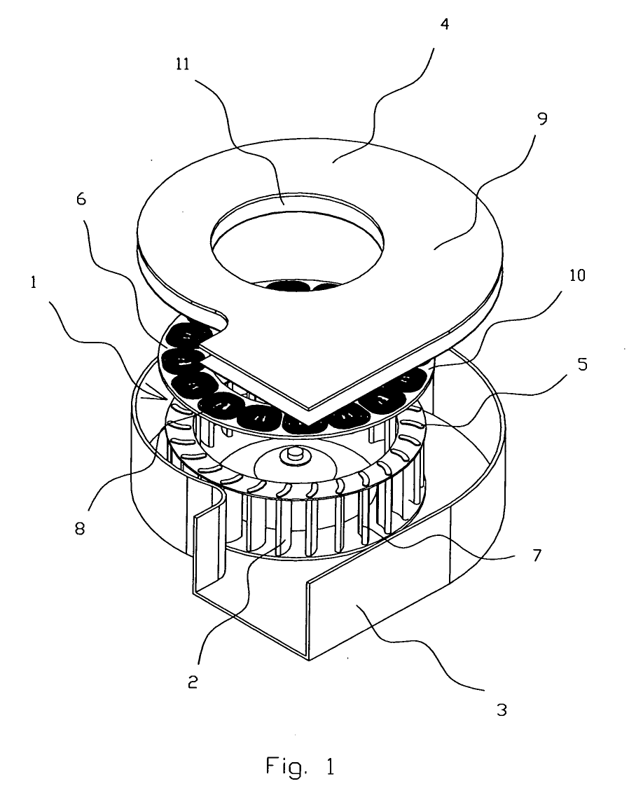

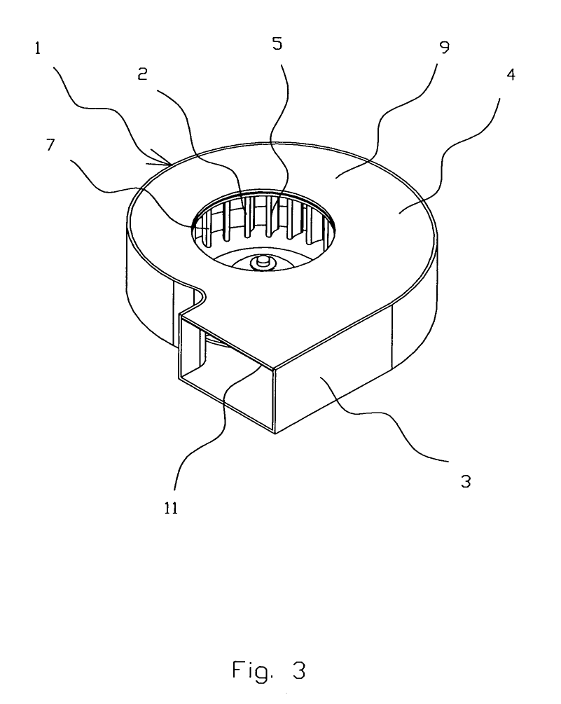

An electric drive for a radial impeller according to the present invention will be described in detail below with reference to the accompanying drawings. FIGS. 1-3 show embodiments of the present invention.

The electric drive 1 (FIGS. 1-3) shown as a part of a radial type blower application assembly with the radial impeller 2, blower casing 3 and blower cover 4. The electric drive 1 for the radial impeller 2 comprises a magnetized rotor 5 and at least one flat stator 6. The magnetized rotor 5 comprises magnetic means 7 rigidly fixed with the radial impeller 2. The magnetic means 7 for example may be made like blades of the radial impeller 2. The flat stator 6 comprises circumferential arrayed coils 8 and at least one ferromagnetic plate 9 placed at an outer side 10 of the flat stator 6 opposite to the magnetized rotor 5, thus shortening magnetic fluxes generated by an interaction of electromagnetic fields of the magnetized rotor 5 and the flat stator 6. The flat stator 6 may be made as a printed circuit board. The layer made of electric insulating material 11 may be placed between the ferromagnetic plate 9 and coils 8 of printed circuit board.

The ferromagnetic plate 9 made from silicon steel comprises at least 3% of silicium preferably. The relative thickness of the ferromagnetic plate 9 in respect to the outer diameter of the radial impeller 2 is 0.001-0.013, the ratio 0.004-0.013 are preferable. The ferromagnetic plate 9 at least partially covered the coils 8 in direction perpendicular to the ferromagnetic plate 9, but the variant when the ferromagnetic plate 9 covered the coils 8 in the same direction in full is more preferable. The ferromagnetic plate 9 may be made like the blower cover 4 for the radial blower application.

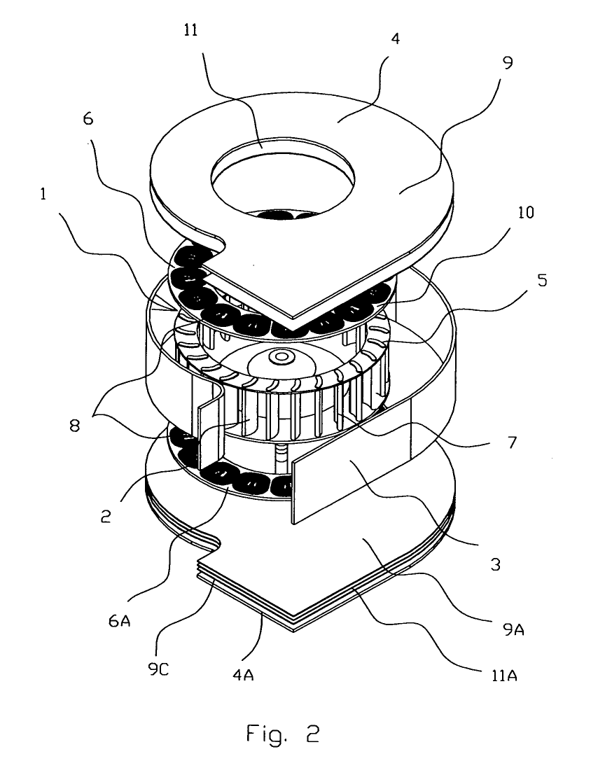

According to another design option of the electric drive 1 the flat stator 6 comprises at least two ferromagnetic plates 9A and 9C (FIG. 2) separated from each other by a layer 11 A made of electric insulating material. As the tests show, such design additionally increases efficiency of the electric drive 1 due to decreases currents inducing in the ferromagnetic plates 9A and 9C comparing with one ferromagnetic plate 9.

According to the second embodiment the electric drive 1 comprises two flat stators 6 and 6A (FIG. 2) placed from both sides of the radial impeller 2 thus increase the useful power of the electric drive 1 when it's required. Such design described with assembly of the electric drive 1 with radial impeller 2, the blower casing 3 and two blower covers 4 and 4A. The upper blower cover 4 made like the ferromagnetic plate 9 separated by the layer 11 made of electric insulating material from coils 8 of printed circuit board etched on flat stator 6. And the down blower cover 4A made like two ferromagnetic plates 9A and 9C separated by the layer 11A made of electric insulating material from coils 8 of printed circuit board etched on flat stator 6A.

The operation of the electric drive 1 by the present invention is substantially similar to the operation as was described in the WO patent No. 03/003547 (PCT/US 02/20224) “Brushless DC Electric Motor” for the same Assignee.

The electric drive 1 operates in the following way. When an electric power supplied to the flat stator 6 of the electric drive 1, alternate electromagnetic fields are created. These electromagnetic fields interact with a magnetic field created by the magnetic means 7 of the magnetized rotor 5. As a result the magnetized rotor 5 is rotated in respect to the axis of rotation. The magnetic fluxes generated by the coils 8 of the flat stator 6 and by the magnetic means 7 of the magnetized rotor 5 are shortened by the ferromagnetic plate 9 made from silicon steel. It increases the intensity of the magnetic field in the area of interaction of magnetic fields of the flat stator 6 and the magnetized rotor 5 and, as a result, the efficiency of the electric drive 1.

During operation inside the ferromagnetic plate 9 the eddy currents increasing losses in intensity of the electromagnetic field are originating. But the summary intensity of the electro-magnetic field in the area of interaction of the magnetic fields of the flat stator 6 and the magnetized rotor 5 is more than in the known electric drives due to the ferromagnetic plate 9 made from silicon steel or another ferromagnetic material which has high eddy current resistance. As a result the currents induced inside the ferromagnetic plate 9 are not strong and the effect of the increasing of the electromagnetic field by the shortening of the magnetic fluxes generated by the flat stator 6 and the magnetized rotor 5 is much more than the effect of the decreasing of the electromagnetic field by the eddy currents. Using of the ferromagnetic plates 9, 9A and 9C also decreases the eddy currents inside the material of the ferromagnetic plates 9, 9A and 9C 9 thus additionally increasing the intensity of the electromagnetic fields.

As the tests show, the efficiency of the electric drive 1 by present invention is higher than for known electric drives. It gives the higher number of revolutions taking the same amount of energy or takes the lower amount of energy having the same number of revolutions, all this without increasing of the total volume of the electric drive 1.

The electric drive for radial impeller may be used not for radial type blower only, but for crossflow type blower, too.

1. An electric drive for a radial impeller comprising a magnetized rotor and at least one flat stator, wherein:
(i) said magnetized rotor comprising magnetic means rigidly fixed with said radial impeller;
(ii) said flat stator comprising circumferential arrayed coils and at least one ferromagnetic plate placed at an outer side of said flat stator opposite to said magnetized rotor, thus shortening magnetic fluxes generated by an interaction of electromagnetic fields of said magnetized rotor and said flat stator.

2. The electric drive as claimed in claim 1, wherein said ferromagnetic plate being made from silicon steel.

3. The electric drive as claimed in claim 2, wherein said ferromagnetic plate is made from silicon steel comprising of at least 3% of silicium.

4. The electric drive as claimed in claim 1, wherein the relative thickness of said ferromagnetic plate in respect to the outer diameter of said radial impeller is 0.001-0.013.

5. The electric drive as claimed in claim 1, wherein said ferromagnetic plate at least partially covered said coils in direction perpendicular to said ferromagnetic plate.

6. The electric drive as claimed in claim 1, wherein said flat stator comprising at least two ferromagnetic plates being separated from each other by. a layer made of electric insulating material.

7. The electric drive as claimed in claim 1, wherein said electric drive comprising two flat stators placed from both sides of said radial impeller.
